(19) United States
(12) Patent Application Publication
(10) Pub. No.: US 2025/0249650 A1
(43) Pub. Date: Aug. 7, 2025

(54) LIGHT CURTAIN WITH SMART BLANKING

(71) Applicant: 167811 CANADA INC DBA ISB, LACHINE (CA)

(72) Inventors: Jorge R. Torosian, Montreal (CA); Eduardo Verberck, Saint-Lazare (CA)

(21) Appl. No.: 18/596,721

(22) Filed: Mar. 6, 2024

Related U.S. Application Data
(60) Provisional application No. 63/549,792, filed on Feb. 5, 2024.

(51) Int. Cl. B30B 15/14; F16P 3/14

(52) U.S. Cl. CPC B30B 15/148; F16P 3/144

(57) ABSTRACT

A light curtain for use with a machine, such as a press brake. The light curtain is connected to a controller of the machine. The light curtain is configured to provide smart blanking, specifically dynamic shape monitoring. In contract to conventional light curtains, the light curtain does not necessarily automatically send a stop signal to the machine in response to a light been being broken. Instead, the light curtain determines whether the break is acceptable in light of data. If the light curtain determines that the break is acceptable in light of data, no stop signal is sent to the machine. In contrast, if the light curtain determines that the break is unacceptable in light of data, the light curtain sends a stop signal to the machine.

### RELATED APPLICATION (PRIORITY CLAIM)

This application claims the benefit of U.S. Provisional Application Ser. No. 63/549,792, filed Feb. 5, 2024, which is hereby incorporated herein by reference.

### BACKGROUND

The present invention generally relates to light curtains, and more specifically relates to a safety light curtain that is configured to provide pinch point safeguarding by smart blanking, in general—preferably on a press brake machine.

Safety light curtains are optical-electronic devices that are used in industrial settings to, for example, prevent a machine operator from getting hurt while operating the machine. Light curtains are typically used with machines such as, but not limited to, press brakes, winders and palletizers. Light curtains can be used instead of mechanical barriers and other types of traditional machine guarding, thereby working to increase the efficiency and productivity of the machines they guard.

A typical light curtain consists of two columns, a column consisting of light emitters and a column consisting of light detectors or receivers. The column of light emitters emits a plurality of light beams that are detected by the column of light receivers. The light beams effectively fan out across an area of the machine which is considered to be high risk regarding possible injury to the operator. When the column of light receivers detects a break in the light beams while the machine is operating, the light curtain sends a stop signal to the controller of the machine, thereby causing the machine to stop moving and preventing possible injury to the operator.

Some types of machines cannot be adequately covered using a conventional, simple light curtain. For example, press brakes are machines designed to bend metal of different dimensions at various angles and are one of the most challenging machines to properly safeguard.

Earlier press brake guarding systems utilized conventional light curtains which often dramatically interfered with production and caused unnecessary shutdowns. A conventional light curtain cannot provide adequate protection and is not practical for use with a press brake in many applications, because even during normal operation of the machine, with no risky interference by the operator, the part itself often breaks the light beams of the light curtain. In fact, the part may break some light beams of the light curtain in one bending step, and still other light beams of the light curtain in subsequent bending steps.

While laser guarding devices are another option, typically they are expensive. Also, they do not guard the entire machine, usually require the machine speed to be significantly reduced, often slow down production, and do not work with all types of tooling and press brakes.

For complex applications such as press brakes being used to bend parts, there exists in the industry more complex light curtains, such as sequentially programmable beam-blank-out systems. These types of systems provide that the operator can program the light curtain so that certain light beams of the light curtain are blanked out at given times during a multiple step bending process. This prevents the part itself from breaking the light beams of the light curtain during the bending process, thereby allowing the machine to operate effectively.

Although sequentially programmable beam-blank-out systems provide functionality which allows them to be used in relatively complex operations of a given machine, such as bending steps of a press brake machine, these systems take into consideration only a static state of the protected field at a given time without taking into consideration the sequence of events ending in the definitive placement of the part in the press.

### SUMMARY

An object of an embodiment of the present invention is to provide a light curtain which is configured to provide smart blanking.

Briefly, an embodiment of the present invention provides a light curtain configured for use with a machine wherein the light curtain is configured to provide smart blanking. The light curtain is connected to the machine. The light curtain comprises a plurality of light emitters and a plurality of light detectors, wherein the light emitters emit beams of light toward the light detectors. The light curtain is configured to send stop signals to the machine depending on the status of light detection. In contrast to conventional light curtains, the light curtain does not necessarily automatically send a stop signal to the machine in response to a light beam being broken. Instead, the light curtain determines whether the break is acceptable in light of configuration data and data collected from the light beams in the past and stored in memory. If the light curtain determines that the break is acceptable in light of data stored in memory, no stop signal is sent to the machine. In contrast, if the light curtain determines that the break is unacceptable in light of data stored in memory, the light curtain sends a stop signal to the machine.

By performing smart blanking, the system performs dynamic shape monitoring. The dynamic shape monitoring can be used to, for example, compute and monitor one or more (preferably all) of the following during the execution of steps of a job: the size and zones of the blanking of the workpiece; the minimum and maximum expected obstruction size during handling of the workpiece in the protective field; shape changes in the protective field during handling; placement time of the workpiece in the blanked zone; and stability of the workpiece in the blanked zone.

In a specific embodiment of the present invention, once the workpiece is finally in the blanked zone, the system evaluates the obstruction history during the placement time and, if required, adds a delay regarding allowing the machine to start moving. During this delay, the obstruction is required to remain stable in the protected field. During monitoring, if the system detects significant deviations from what is expected, the light curtain preferably initiates an interlock condition wherein, in order to proceed, either the obstruction has to be removed or the system has to be manually overridden, such as by having the operator interact with, for example, a touchscreen, manual push button or foot pedal.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a simple block diagram of a prior art light curtain;

FIG. 2 relates to FIG. 1 but provides more detail;

FIG. 3 shows the system architecture of an embodiment of the present invention;

FIG. 4 shows a front view of the system installation;

FIG. 5 shows a side view of the system installation;

FIG. 6 shows an example press brake cycle and associated guarding methods;

FIG. 7 shows an example press cycle and associated blank out steps;

FIGS. 8 and 9, collectively, show five (5) different example cases of obstructions in the the light curtain;

FIG. 10 shows the system rejecting an obstruction;

FIG. 11 shows the signals relating to FIG. 10;

FIG. 12 shows the system validating an obstruction;

FIG. 13 shows the signals relating to FIG. 12;

FIG. 14 shows how the system differentiates between two different types of obstructions;

FIG. 15 provides an example of residual risks;

FIG. 16 provides another example of a residual risk and shows the natural position of an operator's hand during a job;

FIG. 17 shows an example of an obstruction progressing through the light curtain and the signals associated with that progression;

FIG. 18 shows the time for an obstruction to settle in the blanked area and the signals associated therewith; and

FIG. 19 shows a workpiece being processed on a support arm.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention and is not intended to limit the invention to that as illustrated.

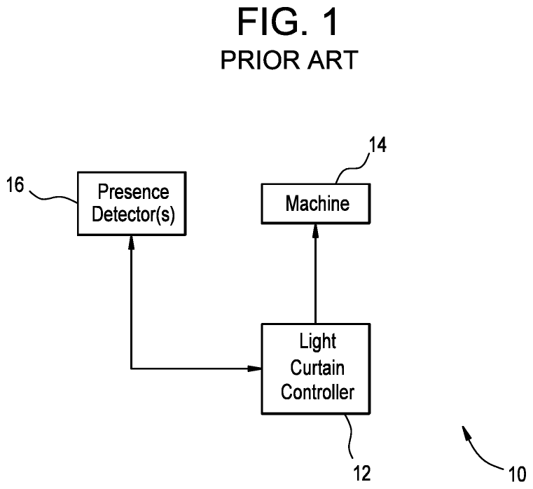

FIG. 1 is a block diagram showing a conventional (i.e., prior art) light curtain protection system 10. As shown, the system 10 provides that a light curtain 16 sends a stop signal to a machine 14, i.e., when there is an unexpected break in the light curtain 16.

The light curtain 16 shown in FIG. 1 could be a very simple light curtain, wherein all the light beams are always on while the machine 14 is operating. When a break in any of the beams of the light curtain 16 is detected, a stop signal is sent from the light curtain 16 to the machine 14.

Alternatively, the light curtain 16 could be a bit more advanced and provide for beam blank-out, wherein some light beams are blanked-out during the process of operating the machine.

Regardless of whether the light curtain 16 is very simple or a bit more advanced, whenever a beam of light is broken, a stop signal is sent from the light curtain 16 to the machine 14 in order to protect the operator.

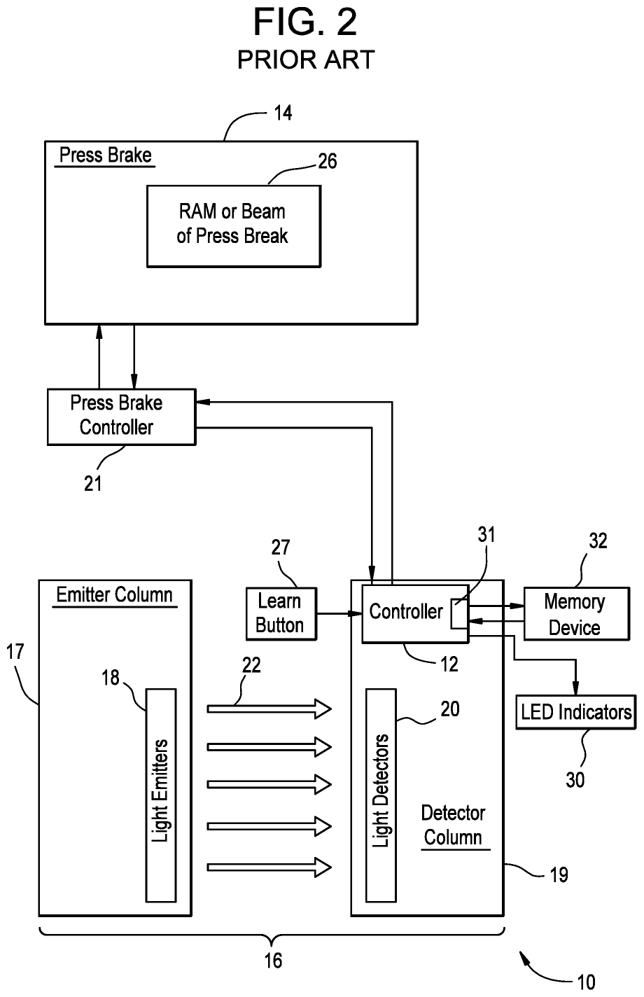

FIG. 2 shows the light curtain 16 in more detail and, despite the present invention not being so limited, shows the specific example where the light curtain 16 is used in connection with a press brake 14. As shown, the light curtain 16 comprises an emitter column 17 which comprises light emitters 18, and a detector column 19 which comprises corresponding light detectors 20.

In use, the columns 17, 19 are spaced apart proximate the press brake 14, and the light emitters 18 are controlled such that they emit beams of light (as indicated with arrows 22 in FIG. 2) toward the light detectors 20. When the light detectors 20 detect an unexpected break in the light beams 22, the light curtain 16 signals the press brake controller 21 to stop the press brake ram 26. As such, during operation of the press brake 14, if the operator sticks a limb between the columns 17, 19 such that the light beams 22 break, the light curtain 16 signals the press brake controller 21 to stop the ram 26 of the press brake 14, thereby possibly preventing injury to the operator.

In the case where the light curtain 16 is part of a sequentially programmable beam-blank-out system, the light curtain 16 operates in a manner which defines one or more blanked-out areas during the process. In other words, the light curtain 16 is programmed such that, during certain stages of the process during which the press brake 14 is being used, certain light beams 22 (i.e., portions of the columns 17, 19) are effectively deactivated such that if an object, such as the part which is being processed, is positioned or comes between the columns 17, 19 at that or those locations, the press brake 14 continues to operate.

The programmable sequential blanking allows a supervisor to configure the light curtain 16 with a sequence of fixed monitored blanking patterns which correspond to each step of a part fabrication process. The light curtain 16 effectively learns these patterns directly from a supervised part processing cycle. As shown in FIG. 2, the light curtain 16 may be provided with a “learn button” 27 or some other user interface which can be interfaced by the operator to effectively send signals to the light curtain 16, thereby programming the light curtain 16.

During programming, the operator operates the machine 14 to fabricate a part, with all the light emitters 18 functioning. During operation, the light curtain 16 learns when certain light detectors 20 (such as which light beams 22 of the columns 17, 19) need to be blanked-out during the process for the part to be fabricated. Subsequently, during normal operation, a machine operator is forced to follow safe operation procedures previously defined by the supervisor.

When set into run mode (i.e., normal operation), the light curtain 16 loads the blanking pattern corresponding to the first step in the job. Thereafter, the blanking pattern is fully monitored, such that the light curtain 16 signals the controller 21 of the machine 14 to stop moving the moveable part 26 of the machine 14 until the blanking pattern is satisfied by the part. Once the part has been properly positioned (i.e., the blanking is satisfied), and the remaining part of the protective field is clear, the light curtain 16 allows the operator to use the controller 21 of the machine 14 to operate the machine 14 such that the moveable part 26 of the machine 14 moves and interacts with the part (such as by performing a bending cycle). During the closing stroke of the ram 26 of the press brake 14, and regardless of its speed, any obstruction of the protective field 22 (other than the blanked-out areas) causes the light curtain 16 to signal the controller 21 of the press brake 14 to stop moving the ram 26 of the press brake 14. Finally, once the ram 26 has stopped at the predetermined dead end of the current cycle, the light curtain 16 preferably loads the blanking pattern corresponding to the next step in the process, such as the next part bending step, so that the operator can continue with the part processing. This sequence is repeated until the part processing (i.e., the job) is completed.

The light curtain 16 provides several beneficial safety features, such as: the light curtain is only blanked-out during those processing steps (such as bending steps) that really need it, and all blanking patterns are fully monitored; the operator is forced to place the part in the exact same position defined during the creating of the job program, and the operator is prevented from initiating a new cycle if he or she misses a step (i.e., the blanking pattern is not fulfilled);

Additionally, the light curtain 16 offers many productivity advantages, such as but not limited to: no need to use slow speed modes, thus increasing the throughput of the press brake 14; the light curtain 16 can be employed in applications using multiple tools of different heights at the same time; and multiple jobs can be programmed and stored, thereby reducing set-up times.

Typically, the light curtain 16 is configured such that it is certifiable under one or more industry standards, such as EN 12622:2010, ISO 13849, IEC 61496-1, IEC 61496-2 and IEC 61508. The light curtain 16 effectively provides safety features in the form of safety distance safeguarding and position monitoring.

In contract to conventional light curtains, a light curtain in accordance with an embodiment of the present invention does not necessarily automatically send a stop signal to the machine in response to a light been being broken. Instead, the light curtain determines whether the break is acceptable in light of data stored in memory. If the light curtain determines that the break is acceptable in light of data stored in memory, no stop signal is sent to the machine. In contrast, if the light curtain determines that the break is unacceptable in light of data stored in memory, the light curtain sends a stop signal to the machine.

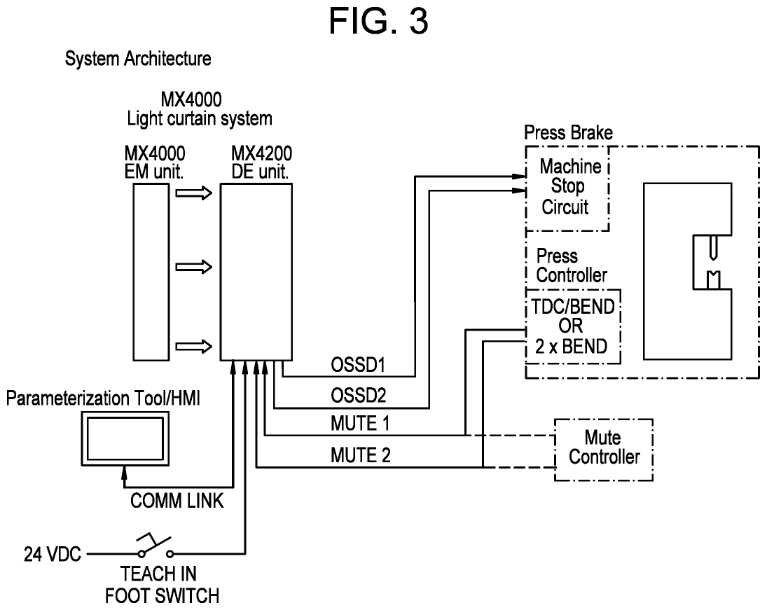

FIG. 3 illustrates a system architecture which can be used to implement smart blanking in accordance with an embodiment of the present invention. As shown in FIG. 3, the system is not much unlike what is shown in FIG. 2, and its operation will be described in more detail below.

As shown in FIG. 3, preferably one or more mute signals (i.e., MUTE 1 and MUTE 2) are selectively sent from the controller of the press brake to the light curtain (or another detection system able to generate such signals, such as a mute controller as shown in FIG. 3), and one or more output signal switching device (OSSD) signals (i.e., OSSD1 and OSSD2) are selectively sent from the light curtain to a machine stop circuit of the press brake. Preferably, the system also comprises a parametrization tool, such as a human machine interface (HMI) (i.e., such as a touchscreen) connected to the light curtain, such as via a communication link (COMM LINK). The parametrization tool might be installed close to the machine controller given that it technically does not perform any safety function.

As shown, the system may also include a foot switch (or press button, etc.) that is also connected to the light curtain. This can be used during blanking programming while in configuration mode. Preferably, it is connected to one of the 24 VDC inputs of the light curtain.

The safety function of the system shown in FIG. 3 is performed by the light curtain system. Specifically, the detector unit is interfaced with a machine stop circuit of the press brake and to the press brake controller or a mute controller to obtain the necessary muting signals (MUTE 1 and MUTE 2). Top dead center (TDC) and/or BEND speed signals from the machine are preferably used for the muting for a press brake guarding feature (via signals MUTE 1 and MUTE 2).

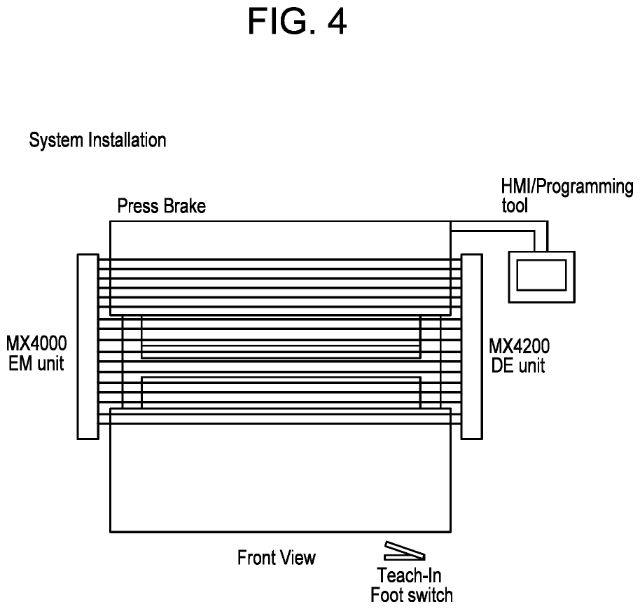

FIG. 4 provides a front view of the system installation, showing the press brake, both columns of the light curtain on each side of the press brake, the parametrization tool, and the foot switch. Preferably, the light curtain is installed following general safety guidelines, such as EN 12622, regarding positioning and distance from the hazardous point of the machine (such as the tool-die pinch point) and following appropriate and effective procedures.

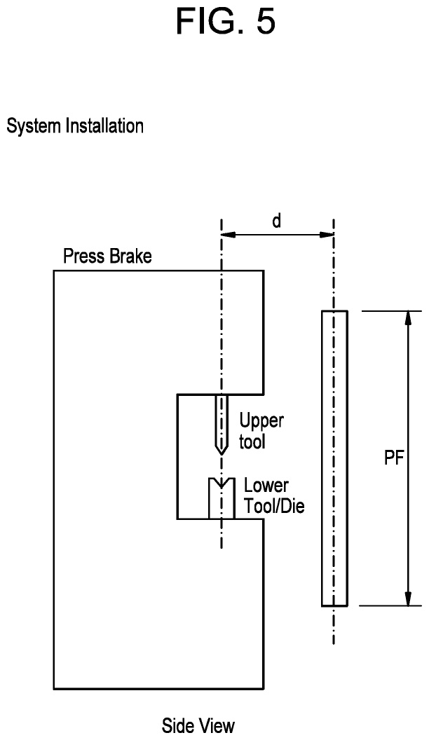

FIG. 5 provides a side view and shows the upper, moveable tool of a downstrokepress brake and the lower, stationary die. FIG. 5 also shows the safety distance “d”, measured from the hazardous point to the centerline of the protective field “PF” of the light curtain. This distance is preferably adjusted at the time of installation as a function of the press brake stopping time, light curtain detection capability (DC) and response time, penetration factor and additional stopping circuitry delays (for example, in accordance with IEC 61496 and EN 12622). Preferably, the minimum length of the protective field “PF” is determined by both the specific safety standards and/or on-site risk assessment (e.g., EN 12622 currently requires that PF>=800 millimeters).

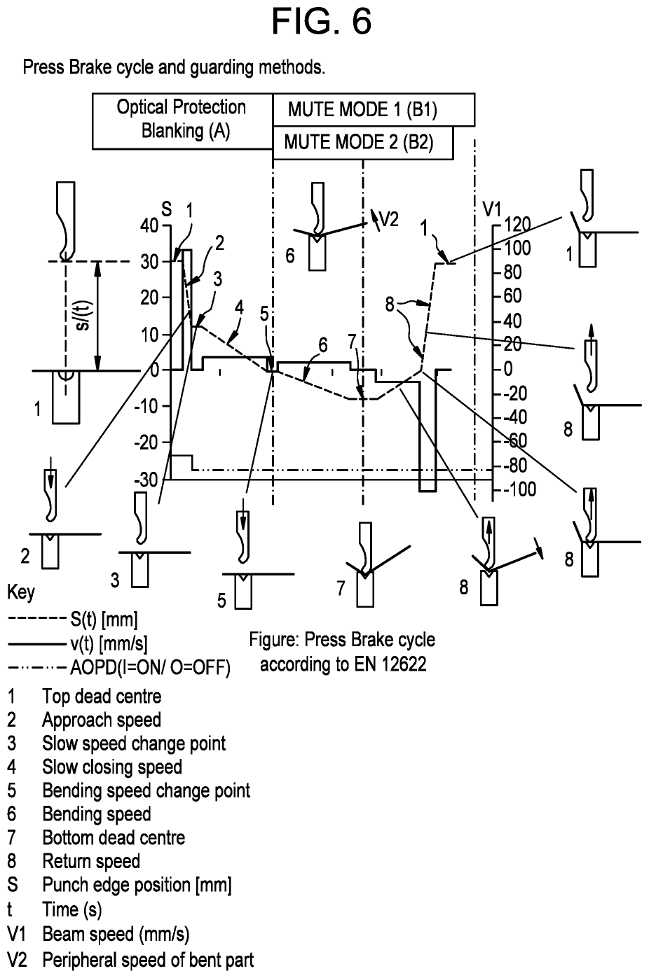

FIG. 6 shows a sample press brake cycle and associated guarding methods (while FIG. 6 illustrates a downstroke press break typical cycle, the same principles would apply to upstroke press breaks). In FIG. 6, the sections indicated with 1 correspond to top dead center (TDC), section 2 identifies the approach speed of the tool, section 3 identifies a slow speed change point, section 4 identifies slow closing speed, section 5 identifies a bending speed change point, section 6 identifies bending speed, section 7 identifies bottom dead center (BDC), and section 8 identifies return speed. The left vertical axis “S” corresponds to the punch edge position (in millimeters), the horizontal axis “t” at the bottom corresponds to time, the right vertical axis “V1” corresponds to beam speed (millimeters/second), and “V2” corresponds to the peripheral speed of the bent part.

As shown in FIG. 6, two main zones are identified—the first zone (A) is the optical protection blanking zone. During this portion of the machine operation cycle, the machine is in the closing stroke and the ram of the press moves from the top dead center (TDC) position toward the bending zone. During this portion of the stroke, the light curtain of the system will allow the press to move only if the following conditions are fulfilled: 1. The protective field is clear anywhere where no blanking is applied; and 2. any blanked area complies with the requirements of the Smart Blanking Mode, described below.

The second main zone comprises a muting zone that comprises two modes-bend portion (MUTE MODE 1(B1)) and press ram retract (MUTE MODE 2(B2)). During this portion of the cycle, the machine is bending the part and the light curtain system is muted through the built in mute for press break feature. Depending on the mode used, the light curtain will be muted from the start of the bend zone until the ram returns to TDC in the upstroke (MUTE MODE 1) or until the press starts moving faster than bend speed in the opening direction (MUTE MODE 2) (i.e., according to EN 12622). Alternatively, some press controllers might directly override the light curtain function during this portion of the cycle. Still other mute modes could be provided, as required.

Preferably, the optical protection provided by the system is configured to provide a blanking implementation with momentary fixed fully monitored blanking with dynamic shape validation (i.e., smart blanking). Preferably, the smart blanking feature allows the system to blank momentarily the flanges of a metal part being manufactured to allow the part to be in the light curtain protective field and allow the machine to start a bend cycle. If the part being manufactured requires the blanking area to change from cycle to cycle, this sequence is preferably automatically applied by the system from a set of supervisor-validated blanking configurations (i.e., a “job”), and each individual blanking configuration (i.e., each “step”). The system validates a press cycle completion by monitoring the MUTE 1 and MUTE 2 input signals (shown in FIG. 3).

The system's guarding does not require the light curtain safety distance (“d” in FIG. 5) to be adjusted because of any momentary blanking required by the metal part. Instead, safety distance is constant and determined at the moment of installation, i.e., according to light curtain DC parameters, response time, and machine stopping performance.

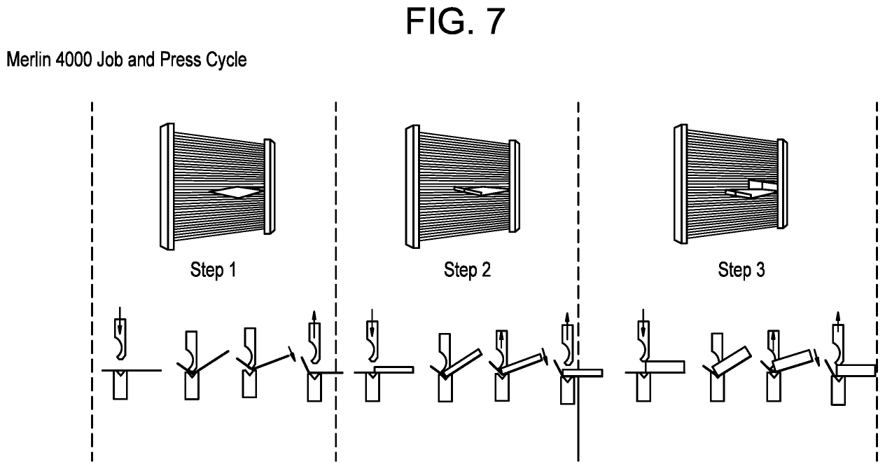

FIG. 7 shows a sample press cycle (i.e., job) and associated blank out steps. In other words, FIG. 7 shows the different blanked areas as the part is manufactured. FIG. 7 illustrates how the system shown in FIG. 3 provides that the blanking configuration changes throughout the process cycle for the part being manufactured. The system provides that this change is automatic and determined by the completion of the press cycle (i.e., sequential change of MUTE 1 and MUTE 2 input signals, as shown in FIG. 3) obtained from the press controller.

Preferably, the system shown in FIG. 3 uses concurrent features to reduce the risk of unintended obstructions being present in the blank zones. For example, preferably the system provides fully monitored blanking for metal flanges greater than 30 millimeters (i.e., as described in EN 12622) wherein the system only uses the most restrictive type of blanking (i.e., described in IEC 61496) which requires the obstruction in the blanking area to be present in an exact size and position.

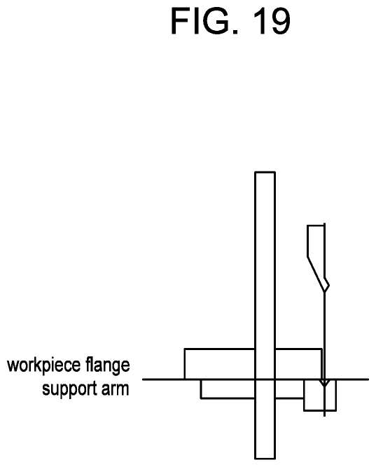

Preferably, the system is also configured to provide for an idle timeout (Tidle) for the bending operation. Specifically, preferably the system monitors the activity of the machine through press brake mute inputs (i.e., MUTE 1 and MUTE 2, shown in FIG. 3) and operator's handling of parts in the die-tool area (see FIGS. 4 and 5). As soon as no activity is detected during Tidle, the system disables the workpiece blanking. Resumption of the bending job sequence after the timeout could be effected through the parameterization tool or by means of the pedal input. Blanking for support arms (such as shown in FIG. 19) or other work piece holders (if used) are treated differently since these are permanent and fixed features attached to the machine. For these, the fully monitored blanking still applies (i.e., the obstruction cannot be removed) and the risk of access to the tooling area should be assessed for the particular application. Preferably, user documentation is provided to cover the proper use of support arm blank and procedures to eliminate any risk to the operator.

With regard to smart blanking, i.e., dynamic shape monitoring, as a measure to reduce even further the event of unintended blanking fulfillment (during the limited time it is active), preferably the system monitors how the obstruction changes in the protected field until it stabilizes (or not) in the intended blanking place. The light curtain of the system is configured to detect changing individual beams in the protected field.

Preferably, the system is configured to discriminate between the metal part whose flange has been saved (i.e., recognized and programmed) and a possible hand or arm of the operator unintendedly moving around the blanked area. Specifically, preferably the system is configured to compute and monitor the following characteristics of the blanked zone during the step execution: size and zones of the blanking for the workpiece; minimum and maximum expected obstruction sizes during handling of the workpiece in the protected field; shape changes in the protective field during handling; placement time of the workpiece in the blanked zone; and stability of the workpiece in the blanked zone.

Once the workpiece is finally in the blanked zone, the system evaluates the obstruction history during the placement time and if required it will add a delay (T_{hold}) (i.e., the OSSD's shown in FIG. 3 will be held in the OFF state). During T_{hold}, the obstruction will be required to remain stable in the protected field. Significant deviations from the values described above or failure to remain stable in the blanked zone during T_{hold} might lead to an interlock condition (i.e., the obstruction has to be removed) or a manual override having to be performed (such as through the parametrization tool or the pedal input).

Regarding computing and monitoring size and zones of the blanking for the workpiece, preferably before the blanking of the workpiece becomes active, the system evaluates if the total size of the blanked zone exceeds 30 millimeters to determine the need for the smart blanking and also if the blanking for the workpiece contains multiple zones (i.e., gaps).

Regarding computing and monitoring minimum and maximum expected obstruction sizes during handling of the workpiece in the protective field, before the blanking for the workpiece becomes active, the system computes minimum and maximum obstruction sizes expected during the handling of the workpiece until the workpiece settles in the blanking zone.

Regarding computing and monitoring shape changes in the protective field during handling, the system monitors variations in size in the obstruction during the handling (e.g., obstructions that grow and shrink too often during the allowed settle-in time may be flagged (i.e., identified) as not related to a valid workpiece or holes in the obstruction not present in the programmed workpiece). Preferably, shape change monitoring sensitivity can be adjusted via a count value that triggers the feature.

Regarding computing and monitoring placement time of the work piece in the blanked zone, the system monitors the time it takes for the workpiece to settle in the proper blanking zone. If the configured placement time T_{placement} is exceeded, this condition will be flagged (i.e., identified). The system provides that the placement time limit is configurable.

Regarding computing and monitoring stability of the workpiece in blanked zone once the workpiece is properly placed in the blanking zone, once the workpiece is in place inside the blanked zone it will be required to be stable, in place for a given time. History of the obstruction during placement will determine the length of the stabilization period.

Regarding the determination of T_{hold}, preferably placement time monitoring is the first condition evaluated. If T_{placement} is less than the configured value, other violations are ignored. On the other hand, if T_{placement} is exceeded and any of the monitored real time obstruction events is triggered (including T_{placement}), OSSD's activation after blanking is satisfied and delayed by T_{hold}. Preferably, each monitor has its own configurable delay and T_{hold} uses the longer delay among those from the monitors that were triggered. Hold time for each monitor is configurable (i.e., T_{hold} minimum size violation, T_{hold} maximum size violation, T_{hold} holes violation, T_{hold} shape violation, T_{hold} placement violation).

During part processing, when there is an empty step smart blanking is disabled. This is because smart blanking is not needed if there is no blanked workpiece. It should be noted that this condition applies to the workpiece and not to any support arms or metal sheet followers (if any are present) as these are static obstructions that are part of the installation of the press break and the risk mitigation is treated differently after assessment of the particular installation. Preferably, this is clearly indicated in a user manual among guidelines for risk mitigation. Once configured, blanking for support arms is continuously monitored, and any discrepancy will prevent the machine from cycling.

In the case where a flange size is less than 30 millimeters, smart blanking is disabled. This condition is supported by the standard EN 12622. While the smart blanking features will be disabled for metal flanges less than or equal to 30 millimeters, standard monitored blanking still applies (i.e., the blanked workpiece should be in place for the machine to run).

Regarding flanges that are greater than 30 millimeters, smart blanking is enabled and the blanking size is consistent with the flange. At this time, the system is configured to perform real time obstruction analysis.

For example, if it is determined that the obstruction is greater than the blanking size maximum, the system implements a stabilization delay and then an interlock that requires either removal of the instruction or a manual override (such as by interacting with the parameterization tool or the foot pedal). Positioning of the workpiece in the protective field during the manufacturing operation is expected to create temporary obstructions larger than the programed blanking but only up to a certain limit (such as when the workpiece enters the protective field at an angle). Obstructions that are too large will cause the system to increase stabilization times once the blanking is satisfied.

If it is determined that the obstruction is less than the blanking size minimum (i.e., the obstruction changes in size repeatedly), the system implements a stabilization delay and then an interlock that requires either removal of the instruction or a manual override. A temporary obstruction that is less than the flange size by a significant amount is flagged (i.e., identified) as noncompliant or suspicious, leading to increased stabilization time requirements (or interlock in extreme cases).

If it is determined that the obstruction includes an unexpected hole, the system implements a stabilization delay and possibly an interlock. If the nominal blanked workpiece has no holes, a temporary hole in the monitored obstruction during placement is flagged (i.e., identified) as noncompliant or suspicious.

The system is configured to monitor the time it takes for the part to be placed in the blanking position. Longer times will require longer stabilization times. This process is adaptive and can lead to interlock in extreme cases.

In summary, the system shown in FIG. 3 is configured to perform smart blanking, specifically dynamic shape monitoring. Preferably, the controller of the light curtain is configured to compute and monitor one or more (preferably all) of the following during step execution: the size and zones of the blanking of the workpiece; the minimum and maximum expected obstruction size during handling of the workpiece in the protective field; shape changes in the protective field during handling; placement time of the workpiece in the blanked zone; and stability of the workpiece in the blanked zone.

Preferably, once the workpiece is finally in the blanked zone, the system evaluates the obstruction history during the placement time and, if required, adds a delay regarding allowing the machine to start moving. During this time, the obstruction is required to remain stable in the protected field. During monitoring, if the system detects significant deviations from what is expected, the controller of the light curtain preferably initiates an interlock condition wherein, in order to proceed, either the obstruction has to be removed or the system has to be manually and proactively overridden, such as by interacting with the parametrization tool or the foot pedal.

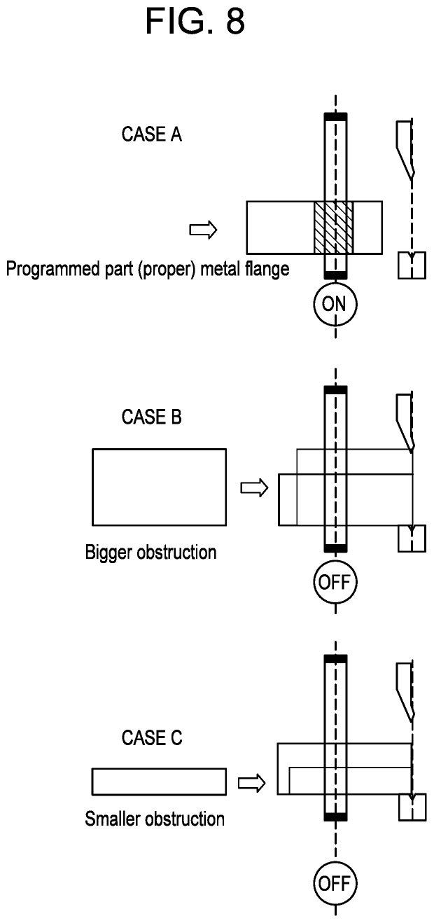

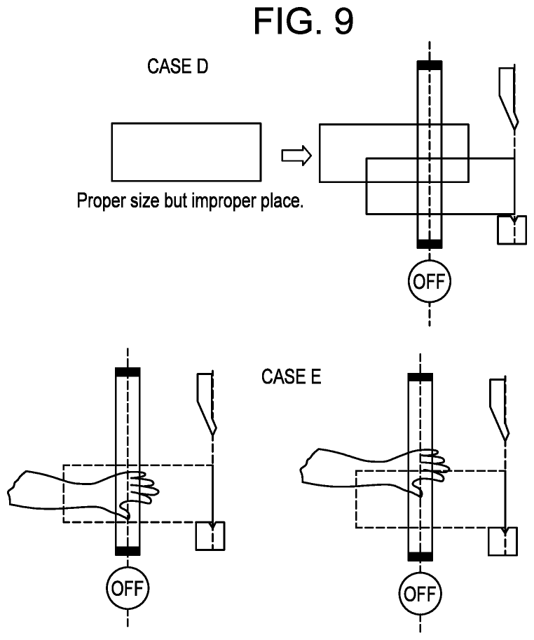

FIGS. 8 and 9, collectively, show five (5) different example cases of obstructions regarding the light curtain. In the five cases shown, differences in the size and position of the part are addressed by the fully monitored blanking condition required by the standard and smart blanking. In Case A (shown at the top of FIG. 8), the part is in the exact position and effectively obstructing the required number of beams. In this situation, the OSSD's (shown in FIG. 3) are ON. In Case B (shown in the middle of FIG. 8), the part obstructs more beams than what is to be expected. In this situation, the OSSD's (shown in FIG. 3) are OFF. In Case C (shown at the bottom of FIG. 8), the part fails to obstruct all the beams that are expected to be obstructed. In this situation, the OSSD's (shown in FIG. 3) are OFF. In Case D (shown at the top of FIG. 9), although the size of the part and the obstruction is valid, the position in the field is not. In this situation, the OSSD's (shown in FIG. 3) are OFF. Finally, in Case E (shown at the bottom of FIG. 9), the part is missing altogether and another obstruction that can constitute a risk (such as the hand of an operator) fails to validate the field. The risk from this type of case is further addressed by the reduced time frame the blanking is active (momentary) and the shape validation feature explained below.

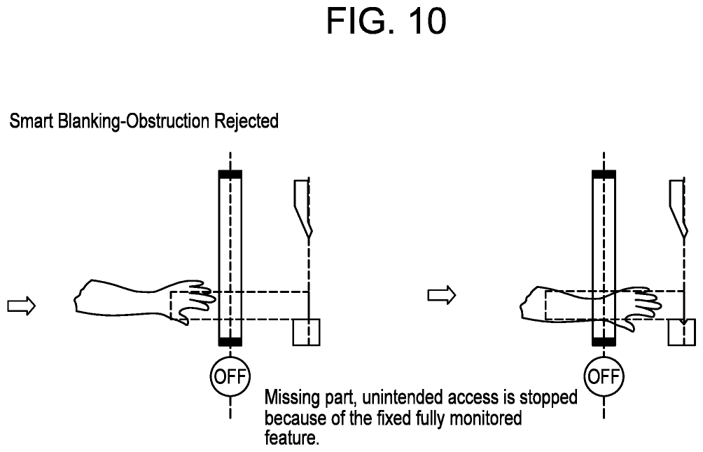

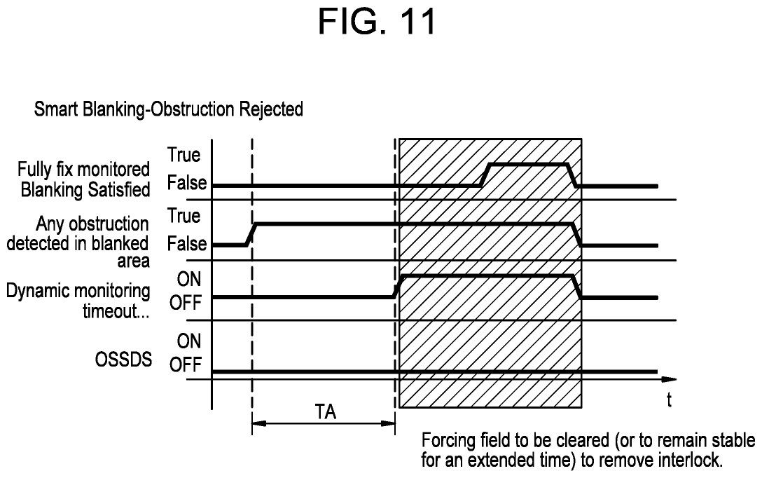

FIG. 10 effectively shows the system of FIG. 3 rejecting an obstruction, while FIG. 11 shows the signals relating to FIG. 10. More specifically, FIG. 10 shows the part being missing and unintended access being stopped because of the fixed fully monitored feature. To avoid the risk of an unintended part validating a blanked area, the system maintains blanked active zones active for the shortest possible time. Machine idle conditions will lead to automatic removal of any blanking configuration. The blanking for a STEP is active only for a reduced time frame from the time the JOB is started, or after the press cycle is completed and a new STEP has been applied. The system does not allow for unintended blanking zones to be present in the protective field. Monitoring of the MUTE 1 and MUTE 2 signals allows the system to determine if the machine is actively manufacturing parts. To further reduce the possibility of unintended obstructions validating a blanking zone, the system requires the vertical flange with the proper size to be detected inside a predetermined time frame. To achieve this shape validation, the time to fulfill the fixed fully monitored area will be limited to a pre-determined time (“TA” in FIG. 11). After this time, the protective field is required to be cleared before allowing the blanked area to be validated again.

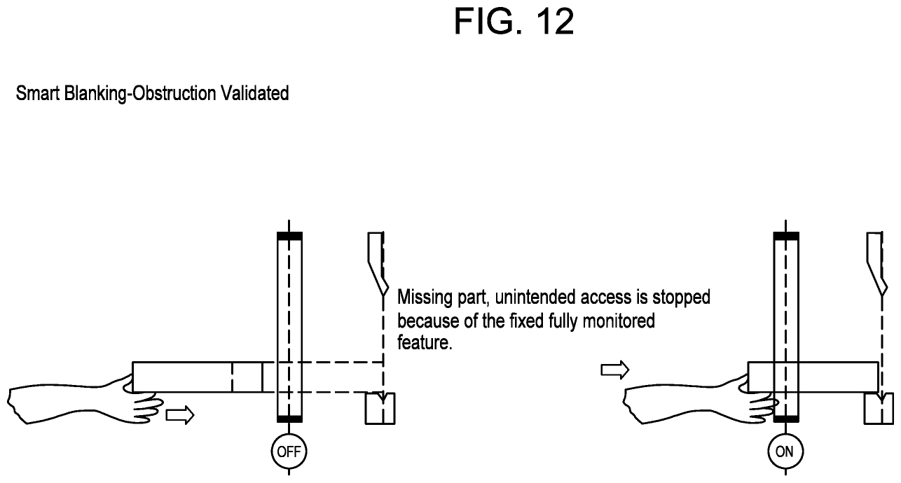

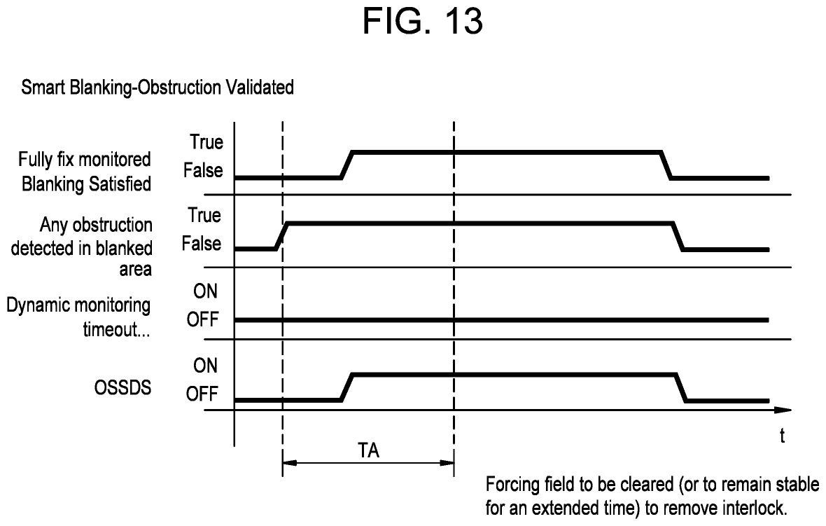

FIG. 12 effectively shows the system of FIG. 3 validating an obstruction, while FIG. 13 shows the signals relating to FIG. 12. More specifically, FIG. 12 shows an operator properly inserting a part into the machine. At first, the part is missing and unintended access is stopped because of the fixed fully monitored feature of the system. However, once the part is inserted into the machine and the light curtain effectively sees what it expects to see, the OSSD signals (shown in FIG. 3) are ON. As shown in FIG. 13, after the pre-determined time “TA”, the field that is being monitored by the system must be cleared (or remain stable for an extended time) in order to prevent an interlock (which requires a manual override).

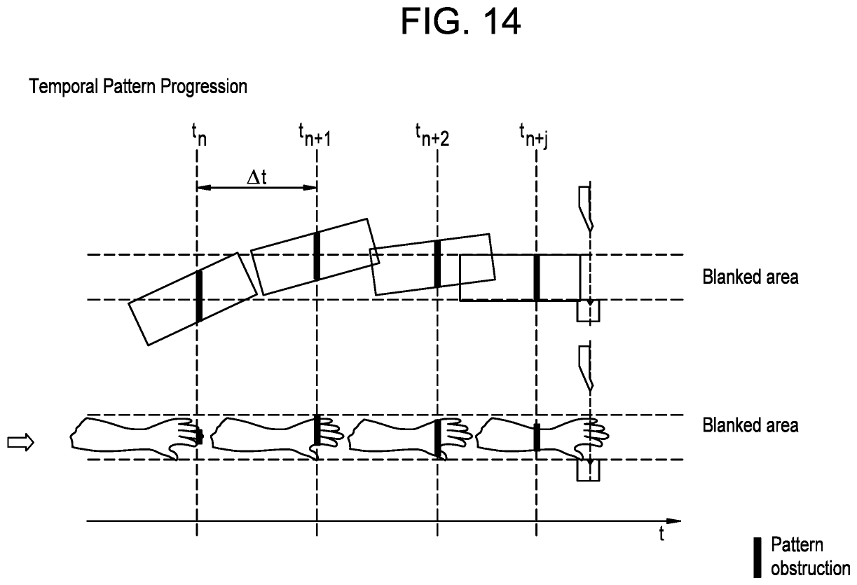

FIG. 14 shows how the system shown in FIG. 3 differentiates between a vertical flange from a valid programmed part (shown at the top) and an unintended obstruction moving around the blanked area (shown at the bottom, in the form of an operator's arm). History of pattern progression allows the system to discriminate between these two scenarios. Based on the history of pattern progression, the system may hold the OSSD signals (shown in FIG. 3) in the OFF state for as long as necessary to validate the proper obstruction with the required level of confidence. Some cases might ultimately require operator validation or removal of the part from the field in order to restart the sequence.

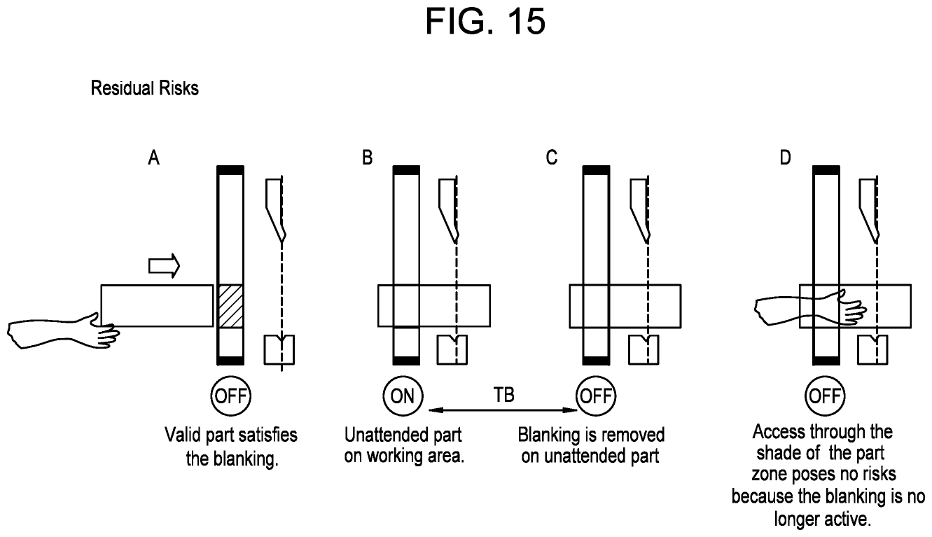

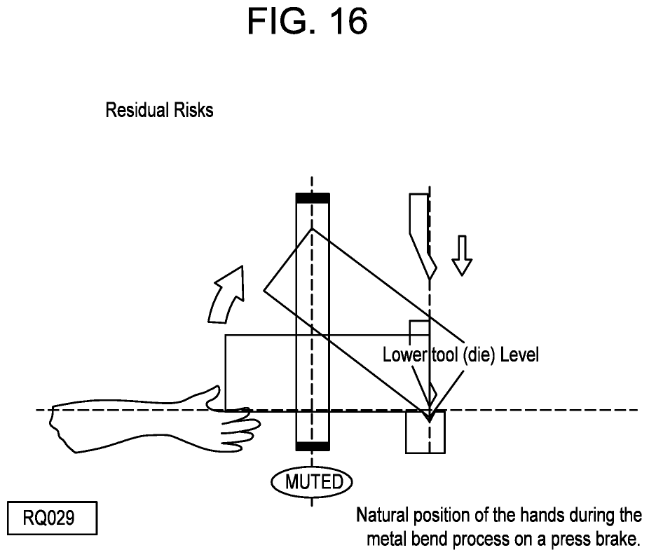

FIGS. 15 and 16, collectively, illustrate how the system shown in FIG. 3 handles two different residual risks.

Specifically, FIG. 15 shows the residual risk in the form of an unattended part being in the blanked area. Initially, a proper part satisfies the blanking (A), but then is left unattended in the working area (B). After a pre-determined time “TB”, the blanking is cancelled (C) avoiding any risk from accessing the dangerous area through the shade of the part (D).

On the other hand, FIG. 16 shows the residual risk in the form of improper handling of a part while the light curtain is already muted by the mute signals. This risk is considered acceptable because the nature of the metal bending manufacturing process on a press brake demands that the operator keep the hands below the lower tool level in order to avoid being hit by the part rotating up as it is bent. FIG. 16 shows the natural position of the hands during the metal bend process.

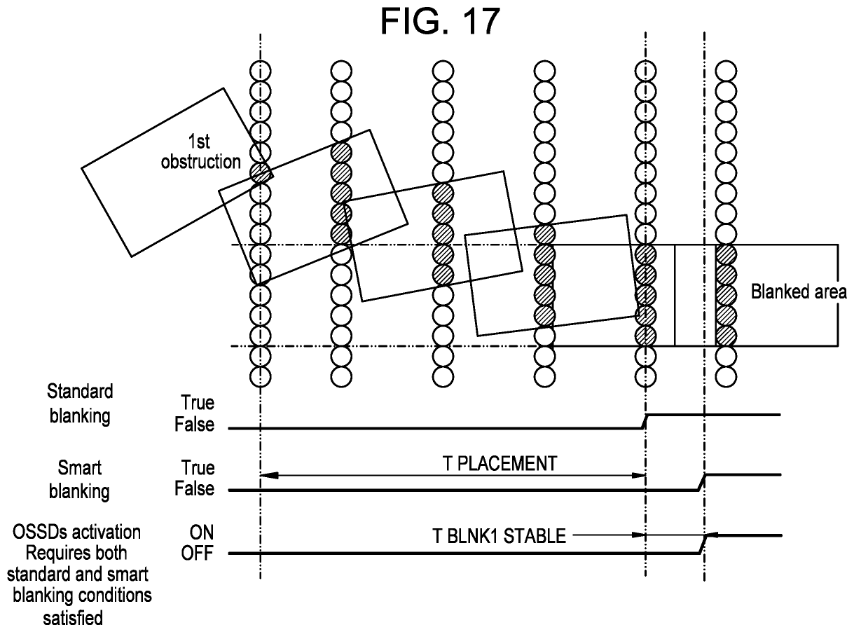

FIG. 17 shows a part being placed in the blanked area (and the associated signals) and is self-explanatory. If the placement time (T_{placement}) exceeds a certain value, the smart blanking of the system forces a delay to reduce the possibility of the blanking being satisfied by the other object that is not the part. If it takes too long for the part to become stable, the instance will be flagged (i.e., detected) and the machine stopped.

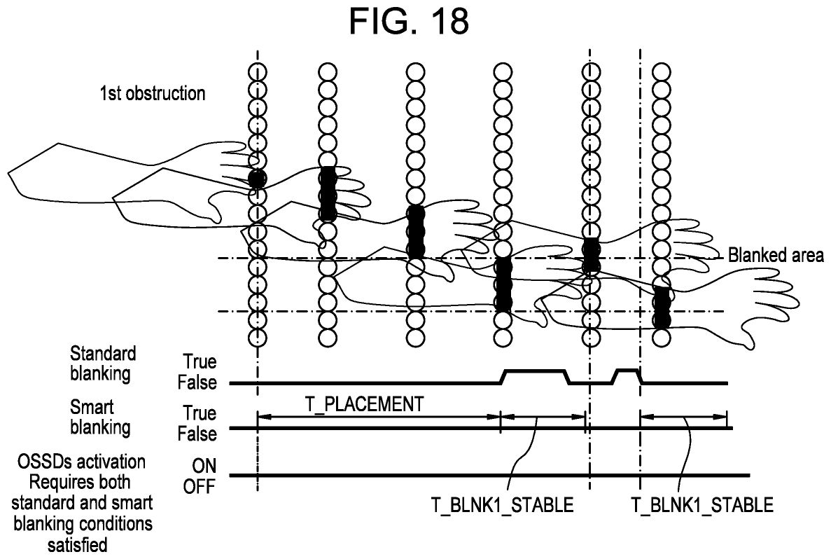

FIG. 18 shows the time it takes for an obstruction to settle in the blanked area (and the associated signals). Specifically, FIG. 18 shows an unintended obstruction moving in the protective field, occasionally satisfying the blanking. Standard blanking alone would cause the OSSD signals (shown in FIG. 3) to chatter (i.e., intermittently degrade). However, the smart blanking of the system takes into consideration an acceptable stabilization time, keeping the OSSD signals (shown in FIG. 3) OFF in the meantime. The expected time it takes to stabilize is adaptive and takes into account the history of the obstruction in the protective field from other conditions, as discussed above.

FIG. 19 shows a workplace flange and a support arm. The system stores internally the blanking configuration for the ongoing step into the following safety configuration parameters: 1. A first safety parameter stores the blanking that corresponds to the support arm; and 2. A second safety parameter stores the blanking that corresponds to the workpiece for the current step of the bending job.

Regarding teaching the system a job, preferably the blanking teaching procedure is triggered by the user through the parameterization tool and/or the foot pedal. The blanking configuration is acquired by the system from the current status of the protective field and is sent back to the configuration tool to be stored and later recalled. To ensure the integrity of the blanking configuration, preferably the system protects same by means of the blanking configuration by means of a cyclic redundancy check stored with the blanking configuration information. This information also includes the step sequence of the given blanking provided by the configuration tool (if the bending job has multiple blanking to be loaded in sequence). Blanking configuration and sequence is validated by the system when the configuration tool attempts to apply a new blanking.

Blanking information and sequence of the blanking in the bending job is preferably protected with a cyclic redundancy check and the system verifies the integrity of the blanking configuration and sequence when it is applied by the configuration tool.

Blanking sequence in the bending job is also stored with the blanking configuration. When a bending job is run, the system checks for proper sequence of the recall blanking.

Preferably, the system is configured such that the operator can override the blanking sequence (using the configuration tool), such as in special cases like: loading a new bending job, bend repeat (double bend), or forcing restart of the sequence when the metal part is dropped due to quality issues.

While specific embodiments of the invention have been shown and described, it is envisioned that those skilled in the art may devise various modifications without departing from the spirit and scope of the present invention.

What is claimed is:

1. A light curtain which is configured for use with a machine, said light curtain configured to emit and detect light beams, wherein the light curtain is configured such that when the light curtain detects a broken light beam, the light curtain determines whether the break is acceptable or not acceptable, wherein if the light curtain determines that the break is acceptable, no stop signal is sent to the machine, wherein if the light curtain determines that the break is unacceptable, the light curtain sends a stop signal to the machine, wherein the light curtain determines whether the break is acceptable or unacceptable in light of historical data based on prior use of the machine.

2. A light curtain as recited in claim 1, wherein the light curtain is configured to compute and monitor a size and zone of blanking of a workpiece.

3. A light curtain as recited in claim 1, wherein the light curtain is configured to compute and monitor a minimum expected obstruction size during handling of a workpiece in a protective field.

4. A light curtain as recited in claim 1, wherein the light curtain is configured to compute and monitor a maximum expected obstruction size during handling of a workpiece in a protective field.

5. A light curtain as recited in claim 1, wherein the light curtain is configured to compute and monitor a minimum and maximum expected obstruction size during handling of a workpiece in a protective field.

6. A light curtain as recited in claim 1, wherein the light curtain is configured to compute and monitor shape changes in a protective field during handling, effectively taking into account the immediate history of the part movement through the protective field.

7. A light curtain as recited in claim 1, wherein the light curtain is configured to compute and monitor placement time of a workpiece in a blanked zone.

8. A light curtain as recited in claim 1, wherein the light curtain is configured to compute and monitor positional stability of a workpiece in a blanked zone.

9. A light curtain as recited in claim 1, wherein the light curtain is configured to, once a workpiece is in a blanked zone, evaluate obstruction history during placement time and, if required, add a delay regarding allowing the machine to start moving.

10. A light curtain as recited in claim 1, wherein the light curtain is configured to monitor whether an obstruction is remaining stable over a pre-determined period of time and, if not, initiate an interlock condition.

11. A light curtain as recited in claim 1, wherein the light curtain is configured to monitor how an obstruction changes in a protected field until the obstruction stabilizes in an intended blanking place, wherein the light curtain is configured to detect changing individual light beams in the protected field.

12. A light curtain as recited in claim 1, wherein the light curtain is configured to compute and monitor a size and zone of blanking of a workpiece, and wherein the light curtain is configured to compute and monitor a minimum and maximum expected obstruction size during handling of a workpiece in a protective field.

13. A light curtain as recited in claim 1, wherein the light curtain is configured to compute and monitor shape changes in a protective field during handling, effectively taking into account the immediate history of the part movement through the protective field, wherein the light curtain is configured to compute and monitor placement time of a workpiece in a blanked zone, and wherein the light curtain is configured to compute and monitor positional stability of a workpiece in a blanked zone.

14. A light curtain as recited in claim 1, wherein the light curtain is configured to, once a workpiece is in a blanked zone, evaluate obstruction history during placement time and, if required, add a delay regarding allowing the machine to start moving, and wherein the light curtain is configured to monitor whether an obstruction is remaining stable over a pre-determined period of time and, if not, initiate an interlock condition.

15. A light curtain as recited in claim 1, wherein the light curtain is configured to monitor how an obstruction changes in a protected field until the obstruction stabilizes in an intended blanking place, wherein the light curtain is configured to detect changing individual light beams in the protected field, wherein the light curtain is configured to compute and monitor a size and zone of blanking of a workpiece, and wherein the light curtain is configured to compute and monitor a minimum and maximum expected obstruction size during handling of a workpiece in a protective field.
